(19) United States
(12) Patent Application Publication
(10) Pub. No.: US 2024/0212916 A1
(43) Pub. Date: Jun. 27, 2024

(54) Common Mode Filter, Filtering Apparatus, Apparatus Having Filtering Function, and Electronic Device

(71) Applicant: Huawei Technologies Co., Ltd., Shenzhen (CN)

(72) Inventors: Long Wu, Shanghai (CN); Wei Di, Shanghai (CN); Tianpeng Wang, Shanghai (CN); Jianjun Zhou, Shanghai (CN)

(21) Appl. No.: 18/558,134

(22) PCT Filed: Apr. 18, 2022
(86) PCT No.: PCT/CN2022/087435

§ 371 Date: Oct. 30, 2023

(30) Foreign Application Priority Data
Apr. 30, 2021 (CN) 202110480306.1

(51) Int. Cl. H01F 27/28; H01F 17/00

(52) U.S. Cl. CPC H01F 27/2804; H01F 17/0013; H01F 2017/0093

(57) ABSTRACT

A filter includes at least two coil assemblies, a plurality of wiring harnesses, at least one dielectric mechanical part, and at least two wiring layers disposed in a stacked manner, where each coil assembly includes a plurality of wires, and one or more wires belonging to different coil assemblies are disposed in each wiring layer; each wiring harness is coupled to two different wires of a same coil assembly, to sequentially couple the wires of each coil assembly together; and each dielectric mechanical part is located between two adjacent wiring layers, wiring layers are stacked together under effect of the dielectric mechanical part, and a volume of each dielectric mechanical part is less than a volume of interlayer space between two wiring layers that are in contact with each dielectric mechanical part.

This application claims priority to Chinese Patent Application No. 202110480306.1, filed with the China National Intellectual Property Administration on Apr. 30, 2021 and entitled “COMMON MODE FILTER, FILTERING APPARATUS, APPARATUS HAVING FILTERING FUNCTION, AND ELECTRONIC DEVICE”, which is incorporated herein by reference in its entirety.

### TECHNICAL FIELD

This application relates to the field of electronic technologies, and in particular, to a common mode filter, a filtering apparatus, an apparatus having a filtering function, and an electronic device.

### BACKGROUND

A multimedia system such as a camera (Camera) or a display (Display) of an electronic device may implement high-speed data transmission through a high-speed data transmission interface (for example, a mobile industry processor interface (Mobile Industry Processor Interface, MIPI for short), a serdes (short for serializer (serializer)/deserializer (deserializer)) interface, a transmission interface (Embedded Display Port, eDP for short) that supports embedded digital audio and video, and the like). However, as the electronic device such as a mobile phone, a smart tablet, a portable computer, or the like is increasingly smaller in size and thinner in thickness, a radio frequency antenna and the multimedia system are deployed in an increasingly tight manner, and a spacing between the radio frequency antenna and the multimedia system is increasingly small, resulting in increasingly high interference and crosstalk risks between a high-speed data transmission path such as an MIPI used by the multimedia system and the radio frequency antenna. How to reduce the interference and crosstalk risks and ensure signal quality in a high-speed data transmission link is an urgent problem to be resolved.

### SUMMARY

To filter out common mode noise on a high-speed data path, this application provides a common mode filter, a filtering apparatus, an apparatus having a filtering function, and an electronic device.

According to a first aspect, an embodiment of this application provides a common mode filter. The common mode filter includes at least two coil assemblies, a plurality of wiring harnesses, at least one dielectric mechanical part, and at least two wiring layers disposed in a stacked manner, where
each coil assembly includes a plurality of wires, and one or more wires belonging to different coil assemblies are disposed in each wiring layer;
each wiring harness is connected to two different wires of a same coil assembly, to sequentially connect the plurality of wires of each coil assembly together; and
each dielectric mechanical part is located between two adjacent wiring layers, a plurality of wiring layers are stacked together under effect of a plurality of dielectric mechanical parts, and a volume of each dielectric mechanical part is less than a volume of interlayer space between two wiring layers that are in contact with each dielectric mechanical part.

According to the first aspect, wires of a same coil assembly of the common mode filter are located in different wiring layers, and the wiring layers are maintained to be stacked in parallel or approximately parallel with each other under support of the plurality of dielectric mechanical parts, so that a dielectric loss of the common mode filter is reduced, a differential mode loss of the common mode filter is reduced, and the common mode filter has better symmetry and lower mode conversion. This can ensure signal quality while common mode noise carried by a high-speed data path and the like is filtered out.

According to the first aspect, in a first possible implementation of the common mode filter, each dielectric mechanical part includes at least one mechanical branch, and each mechanical branch is in contact with at least a wiring corner of one wire in one adjacent wiring layer. At least a wiring corner of each wire in a wiring layer is in contact with the dielectric mechanical part, so that the wiring layer may be supported by the dielectric mechanical part, to ensure that a parallel state between the plurality of wiring layers may be stably maintained.

According to the first possible implementation of the first aspect, in a second possible implementation of the common mode filter, a cross sectional shape of each mechanical branch perpendicular to the wiring layer includes any one of the following: a rectangle, a trapezoid, a parallelogram, and a combination shape formed by at least two shapes of the rectangle, the trapezoid, and the parallelogram. In this way, a shape and a size of a section T of each mechanical branch of the dielectric mechanical part may be set based on a support requirement determined by a winding shape, a length, and the like of a wire in the two wiring layers that are in contact with the dielectric mechanical part, and a volume of each mechanical branch may be minimized as much as possible while the support requirement is met, to further reduce a low differential mode loss of the common mode filter.

According to the first or second possible implementation of the first aspect, in a third possible implementation of the common mode filter, all mechanical branches of a same dielectric mechanical part are fixedly connected together. In this way, structural stability of the dielectric mechanical part may be enhanced, thereby improving structural stability of the common mode filter.

According to any one of the first aspect or the possible implementations of the first aspect, in a fourth possible implementation of the common mode filter, a shape of an orthographic projection of each dielectric mechanical part in any wiring layer includes any one of the following: a grid-shaped shape, a star-shaped shape, a square-shaped shape, a rectangle, an X-shaped shape, a round shape, a ring shape, an I-shaped shape, a cross shape, and a combination shape formed by at least two shapes of the grid-shaped shape, the star-shaped shape, the square-shaped shape, the rectangle, the X-shaped shape, the round shape, the ring shape, the I-shaped shape, and the cross shape. In this way, the shape of the orthographic projection of the dielectric mechanical part may be set randomly based on a structure support requirement of the common mode filter, and the volume of the dielectric mechanical part may be minimized as much as possible while the support requirement is met, to further reduce the low differential mode loss of the common mode filter.

According to any one of the first aspect or the possible implementations of the first aspect, in a fifth possible implementation of the common mode filter, a filler is further disposed in a part of or all of the plurality of wiring layers, and the filler includes a porous solid filler and/or a gas filler.

According to the fifth possible implementation of the first aspect, in a sixth possible implementation of the common mode filter, a volume of the filler in each wiring layer is less than or equal to 80% of a total volume of the wiring layer in which the filler is located.

According to the fifth or sixth possible implementation of the first aspect, the structural stability of the common mode filter may be enhanced, and the differential mode loss may also be minimized as much as possible. Under an equal condition, the smaller the volume of the filler in the wiring layer, the lower the differential mode loss of the common mode filter.

According to the fifth or sixth possible implementation of the first aspect, in a seventh possible implementation of the common mode filter, the porous solid filler in each wiring layer includes at least one of the following: insulation foam, porous ceramic, and porous resin.

According to any one of the first aspect or the possible implementations of the first aspect, in an eighth possible implementation of the common mode filter, the common mode filter further includes at least one connector, and each connector is configured to fixedly connect any two dielectric mechanical parts together. Disposing the connector may improve the structural stability of the common mode filter.

According to the eighth possible implementation of the first aspect, in a ninth possible implementation of the common mode filter, the common mode filter further includes at least one interlayer via hole, and each interlayer via hole is used to accommodate a corresponding connector.

According to any one of the fifth to seventh possible implementations of the first aspect, in a tenth possible implementation of the common mode filter, the porous solid filler in each wiring layer is fixedly connected to a dielectric mechanical part that is in contact with the wiring layer. In this way, the structural stability of the common mode filter may be enhanced.

According to any one of the first aspect or the possible implementations of the first aspect, in an eleventh possible implementation of the common mode filter, the common mode filter further includes:
a plurality of pins, disposed on a surface of any one of two outermost wiring layers of the plurality of wiring layers.

According to any one of the first aspect or the possible implementations of the first aspect, in a twelfth possible implementation of the common mode filter, the volume of each dielectric mechanical part is less than or equal to 80% of the volume of the interlayer space between two wiring layers that are in contact with each dielectric mechanical part; and/or the volume of each dielectric mechanical part is less than or equal to 80% of a volume of a wiring layer that is in contact with each dielectric mechanical part. In this way, the structural stability of the common mode filter may be ensured, and the differential mode loss may also be reduced. The smaller the volume of the dielectric mechanical part, the lower the differential mode loss of the common mode filter.

According to any one of the first aspect or the possible implementations of the first aspect, in a thirteenth possible implementation of the common mode filter, at least two wires in a wiring layer whose quantity of wires is greater than or equal to 2 are wound in parallel. In this way, the symmetry of the common mode filter may be improved.

According to a second aspect, an embodiment of this application provides a filtering apparatus. The filtering apparatus includes:
the common mode filter according to any one of the first aspect or the possible implementations of the first aspect; and
a first printed circuit board, configured to carry the common mode filter, where
each pin of the common mode filter is fixedly connected to a corresponding solder pad on the first printed circuit board.

According to the second aspect, in a first possible implementation of the apparatus, a manner in which each pin of the common mode filter is fixedly connected to the corresponding solder pad on the first printed circuit board includes any one of the following: a wire bonding connection, a welding connection, and a conductive adhesive bonding connection.

According to the second aspect or the first possible implementation of the second aspect, in a second possible implementation of the apparatus, insulation adhesive is disposed in a part of or all of an area on a surface of the common mode filter, to transfer the common mode filter to a corresponding location on the first printed circuit board by using the insulation adhesive.

According to a third aspect, an embodiment of this application provides an apparatus having a filtering function. The apparatus includes: a functional device, an auxiliary device, and a second printed circuit board, the functional device and the auxiliary device are mounted on the second printed circuit board, and the functional device and the auxiliary device are coupled and connected; and
the functional device includes the common mode filter according to any one of the first aspect or the possible implementations of the first aspect, and the auxiliary device includes an amplifier and/or a passive device.

According to a fourth aspect, an embodiment of this application provides an electronic device. The electronic device includes:
the common mode filter according to any one of the first aspect or the possible implementations of the first aspect; or
the filtering apparatus according to the second aspect or the possible implementations of the second aspect; or
the apparatus having the filtering function according to the third aspect.

These aspects and other aspects of this application are more concise and more comprehensible in descriptions of the following (a plurality of) embodiments.

### BRIEF DESCRIPTION OF DRAWINGS

The accompanying drawings included in this specification and constituting a part of this specification and this specification jointly show example embodiments, features, and aspects of this application, and are intended to explain the principles of this application.

FIG. 1A to FIG. 1G are schematic diagrams of structures of a schematic common mode filter according to an embodiment of this application;

FIG. 2A to FIG. 2D are a 3D diagram, a main view, a side view, and a top view of another schematic common mode filter according to an embodiment of this application;

FIG. 2E to FIG. 2H are a 3D diagram, a main view, a side view, and a top view of still another schematic common mode filter according to an embodiment of this application;

FIG. 3A and FIG. 3B are cross section diagrams of a common mode filter according to an embodiment of this application;

FIG. 3C is a schematic diagram of a structure of a common mode filter according to an embodiment of this application;

FIG. 3D is a schematic diagram of a structure of a schematic dielectric mechanical part according to an embodiment of this application;

FIG. 4A and FIG. 4B are schematic diagrams of structures of a schematic common mode filter and a dielectric mechanical part according to an embodiment of this application:

FIG. 5A and FIG. 5B are schematic diagrams of structures of another schematic common mode filter and a dielectric mechanical part according to an embodiment of this application;

FIG. 6A and FIG. 6B are schematic diagrams of structures of still another schematic common mode filter and a dielectric mechanical part according to an embodiment of this application;

FIG. 7A and FIG. 7B are schematic diagrams of structures of a connector according to different embodiments of this application;

FIG. 8A and FIG. 8B are schematic diagrams of structures of a dielectric mechanical part of yet another schematic common mode filter according to an embodiment of this application:

FIG. 9 is a schematic diagram of a structure of a filtering apparatus according to an embodiment of this application;

FIG. 10A-1 and FIG. 10A-2, FIG. 10B, and FIG. 10C-1 to FIG. 10C-3 are schematic diagrams of manufacturing processes of a common mode filter according to an embodiment of this application; and

FIG. 11 is a schematic diagram of a structure of an electronic device according to an embodiment of this application.

### DESCRIPTION OF EMBODIMENTS

The following describes various example embodiments, features, and aspects of this application in detail with reference to the accompanying drawings. Identical reference signs in the accompanying drawings represent elements that have same or similar functions. Although various aspects of embodiments are shown in the accompanying drawings, unless otherwise specified, the accompanying drawings do not need to be drawn to scale.

The specific term “example” herein means “used as an example, embodiment, or illustration”. Any embodiment described as an “example” herein is not necessarily explained as being superior or better than other embodiments.

In addition, to better describe this application, numerous specific details are given in the following specific implementations. A person skilled in the art should understand that this application may also be implemented without some specific details. In some examples, methods, means, elements, and circuits that are well-known to a person skilled in the art are not described in detail, so that the subject of this application is highlighted.

An electronic device is often subject to electromagnetic interference (EMI (Electromagnetic Interference)) during operation.

Electromagnetic interference is a type of noise conducted in a conductive medium or an electromagnetic wave radiated in space. The electromagnetic interference is spread in air or transmitted through a power cable or a signal cable, which may damage normal operation of the electronic device and seriously affect and block communication.

The electromagnetic interference generally may be divided into “conducted interference” and “radiated interference”. It should be understood that the “conducted interference” may be referred to as “conducted noise”, and the “radiated interference” may be referred to as “radiated noise”. The conducted noise is mainly propagated through a conductive wire body. The radiated noise is mainly coupled through space. For example, a high-frequency signal cable, a pin of an integrated circuit, various connectors, and the like may become a radiated interference source having an antenna feature, and can transmit the electromagnetic wave and affect normal operation of another system or another sub-system in the system.

Electromagnetic interference of high-speed data link transmission is mainly the conducted noise, and the conducted noise may be divided into differential mode noise and common mode noise.

A circuit is on a basis of a current flowing along a path for one cycle. For example, a signal source and a load are connected through two conducting wires. The two conducting wires are respectively for inflow and outflow of the current, and currents of a same magnitude flow in opposite directions to each other. Therefore, a sum is consistently zero. A current flowing in this manner is referred to as a common mode current. Similarly, noise flowing in this manner is referred to as common mode noise.

Because direct capacitance exists between the signal source and the load with respect to a ground, as a result, a part of currents flow from a ground of a signal source end to a ground of a load end. Therefore, flow directions of the two conducting wires between the signal source and the load are the same. This type of current is referred to as a common mode current, also referred to as the common mode noise. For example, at a specific frequency, when a ground pin conductor of the signal source and ground capacitance form a resonance structure similar to an antenna, the common mode noise is introduced. During actual application, impact of a temperature change and various ambient noises, and the like may be considered as common mode interference. However, if ground noise of the two wires is reduced differently in a transmission process, a voltage difference exists between the two wires. In this case, the common mode noise is transformed into the differential mode noise. Therefore, it is important to eliminate the common mode noise.

A common mode filter is usually configured to filter out common mode noise on a high-speed data path, and generally includes at least two coils. Two coils are used as an example. The two coils have a same quantity of turns and a same phase, and are wound in parallel around a same iron core. The two coils are also referred to as a common mode suppression choke or a common mode choke. Each coil in the common mode choke has a feature of being wound in a same phase. When common mode currents with an equal amplitude and in a same direction flow through the common mode choke, because the common mode currents are isotropic, magnetic fields generated in a common mode choke coil are also in a same direction, to increase inductive reluctance of the common mode choke coil, enable the coil to exhibit high impedance, and generate strong damping effect. Therefore, the common mode current may be attenuated to implement filtering effect. However, there is no attenuation effect on differential mode currents with an equal amplitude and in a reverse direction. A common mode filter with more than two wires (that is, more than two coils) has a wide application prospect in an aspect of high-speed data transmission, for example, a common mode filter in a data transmission manner of a C-PHY interface (where PHY is short for port physical layer, Port Physical Layer in English, and C-PHY is a standard of a port physical layer specified by a MIPI) for the MIPI (Mobile Industry Processor Interface, mobile industry processor interface). The common mode filter includes three coils, and the three coils can filter out common mode noise through coupling and pairwise differential.

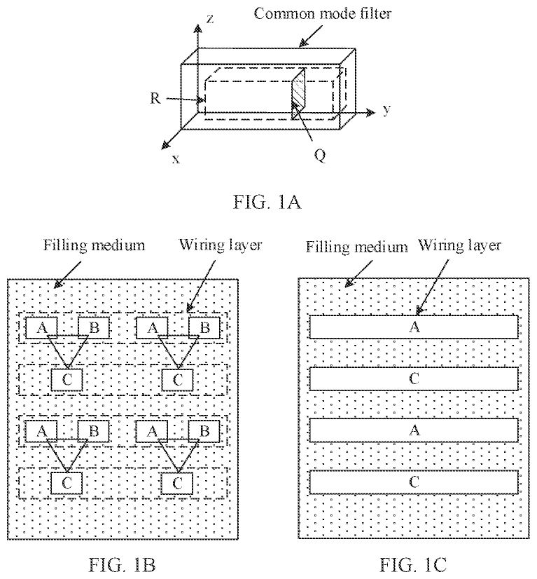

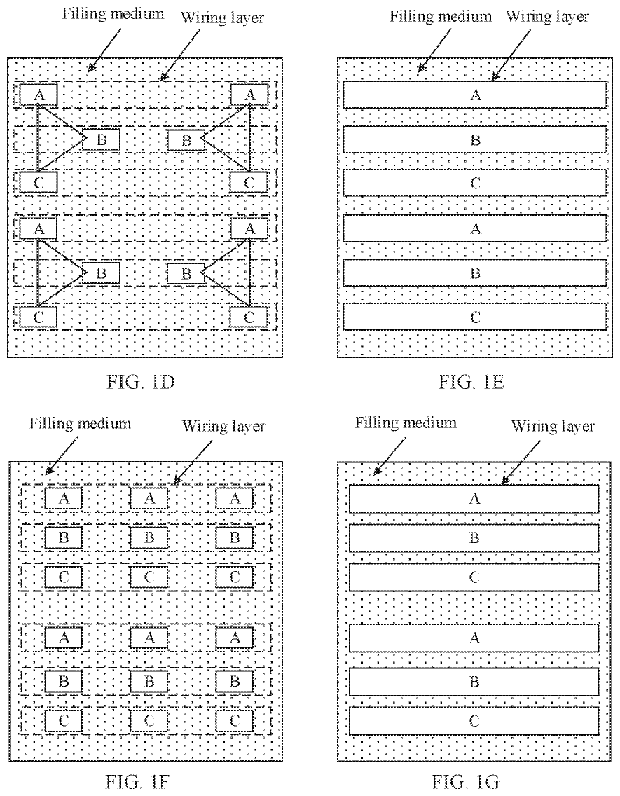

FIG. 1A to FIG. 1G are schematic diagrams of structures of a schematic common mode filter according to an embodiment of this application. FIG. 1A is a 3D diagram of a common mode filter having three coil assemblies. FIG. 1B, FIG. 1D, and FIG. 1F may be cross section diagrams of the filter shown in FIG. 1A along a plane (for example, a plane Q) that is parallel to an x-axis and a y-axis and that is located in space R. FIG. 1C, FIG. 1E, and FIG. 1G may be cross section diagrams of the filter shown in FIG. 1A along a plane (for example, a plane that is in the space R and that is perpendicular to a plane Q and parallel to a z-axis and the y-axis) that is parallel to the z-axis and the y-axis and that is located in the space R. The common mode filter in the related technology shown in FIG. 1A to FIG. 1G includes three coil assemblies, and each coil assembly includes a plurality of wires located in different wiring layers. As shown in FIG. 1B to FIG. 1G, wires marked as “A” in the different wiring layers belong to the first coil assembly, wires marked as “B” in the different wiring layers belong to the second coil assembly, and wires marked as “C” in the different wiring layers belong to the third coil assembly. Wiring layout manners of the common mode filter include the following several manners: As shown in FIG. 1B and FIG. 1C, wires of the three coil assemblies are arranged in a triangle, wires “A” of the first coil assembly and wires “B” of the second coil assembly are in a same wiring layer, and wires “C” of the third coil assembly are separately disposed in a wiring layer different from that of the wires A and the wires B. As shown in FIG. 1D and FIG. 1E, the wires of the three coil assemblies are also arranged in an equilateral triangle, and wires “A”, “B”, and “C” of the three coil assemblies are not in a same wiring layer. As shown in FIG. 1F and FIG. 1G, the wires of the three coil assemblies are not in a same wiring layer, and wires “A”, “B”, and “C” of the three coil assemblies are sequentially arranged in a vertical direction. In addition, a filling medium is disposed in an area other than the wires in the wiring layers and an interlayer area between the wiring layers of the common mode filter shown in FIG. 1B to FIG. 1G, so that each wire is wrapped in the filling medium. In this way, interference and crosstalk between a high-speed data path and a radio frequency antenna may be reduced, to ensure signal quality in a high-speed data transmission link.

This application provides another common mode filter with a low differential mode loss. The differential mode loss of the common mode filter mainly includes a conductor loss and a dielectric loss of the common mode filter, where the conductor loss is mainly determined by a wiring material of a coil assembly, and the dielectric loss is related to a filling medium. In some embodiments, a method for reducing the dielectric loss may be implemented by changing the filling medium in the common mode filter to a material with a smaller Dk (relative permittivity) and/or df (dielectric loss factor). Dk is a physical quantity for measuring a polarization degree of a dielectric. A larger Dk value of the dielectric indicates a higher polarization degree of the dielectric, and a higher charge Q value of the dielectric indicates a stronger capability of storing electric energy of the dielectric, a larger capability of blocking signal transmission, and a larger dielectric loss of the dielectric. The loss factor df is a physical quantity that represents hysteresis effect of a dielectric conductivity and dielectric polarization. Due to hysteresis effect in an alternating electric field, a phase difference exists in phasors of currents and voltages flowing through the dielectric, that is, a phase angle δ is formed. A tangent value of the phase angle δ is a tan value, and is also referred to as df, the dielectric loss factor, and a dielectric loss tangent. An energy loss caused by the hysteresis effect between the dielectric conductivity and the dielectric polarization is referred to as a dielectric loss. The larger the df, the more a power loss, and the larger the dielectric loss of the dielectric.

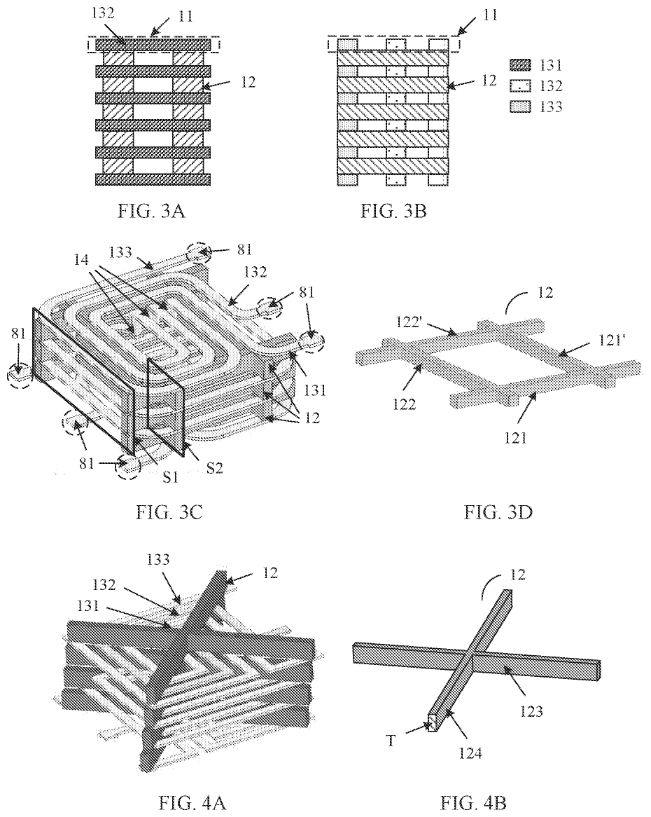

Another common mode filter 100 with a low differential mode loss provided in this application includes at least two coil assemblies, where each coil assembly includes a plurality of wires located in different wiring layers (for example, wires 131 located in wiring layers 11 in FIG. 3B belong to a same coil assembly); a plurality of wiring harnesses (for example, 14 in FIG. 3C); at least one dielectric mechanical part (for example, 12 in FIG. 3C or 12 in FIG. 4A); and at least two wiring layers (for example, 11 in FIG. 3A to FIG. 3C) disposed in a stacked manner. One or more wires belonging to different coil assemblies are disposed in a same wiring layer. Each wiring harness is connected to two different wires that belong to a same coil assembly (for example, each wiring harness may be separately connected to two wires that belong to a same coil assembly and a shortest interlayer distance exists between the wiring layers in which the two wires are located), to sequentially connect a plurality of wires of each coil assembly together. Each dielectric mechanical part is located between two adjacent wiring layers, and a plurality of wiring layers are stacked together under effect of a plurality of dielectric mechanical parts and may maintain a parallel state or an approximately parallel state with each other under support of the dielectric mechanical part. A volume of each dielectric mechanical part is less than a volume of interlayer space between two wiring layers that are in contact with each dielectric mechanical part, that is, the dielectric mechanical part between the wiring layers does not occupy the entire interlayer space, so that a filling medium in the common mode filter is reduced, to reduce the dielectric loss of the common mode filter, reduce the differential mode loss of the common mode filter, and improve a differential mode loss index Sdd21. In addition, in some embodiments, a relative permittivity Dk and/or df (dielectric loss factor) of the dielectric mechanical part may be reduced. In the common mode filter provided by this application, the wires of a same coil assembly are located in different wiring layers. A dielectric constant of an interlayer dielectric (namely, each dielectric mechanical part) of the wiring layer is reduced, so that parasitic capacitance is also reduced, and main factors affecting symmetry between the coil assemblies are an electrical length and impedance matching of all wires of each coil assembly. Because the wires of a same coil assembly are located in different wiring layers, a length of the wires of each coil assembly in different wiring layers and a winding structure between the wires in a same wiring layer may be adjusted to improve symmetry of the common mode filter, improve mode conversion of the common mode filter (that is, reduce a possibility of a common mode signal input to the common mode filter being converted into a differential mode signal for output, and reduce a possibility of the differential mode signal input to the common mode filter is converted into the common mode signal for output), reduce a vertical transfer loss, and increase vertical transfer loss indexes Sdc21 and Scd21.

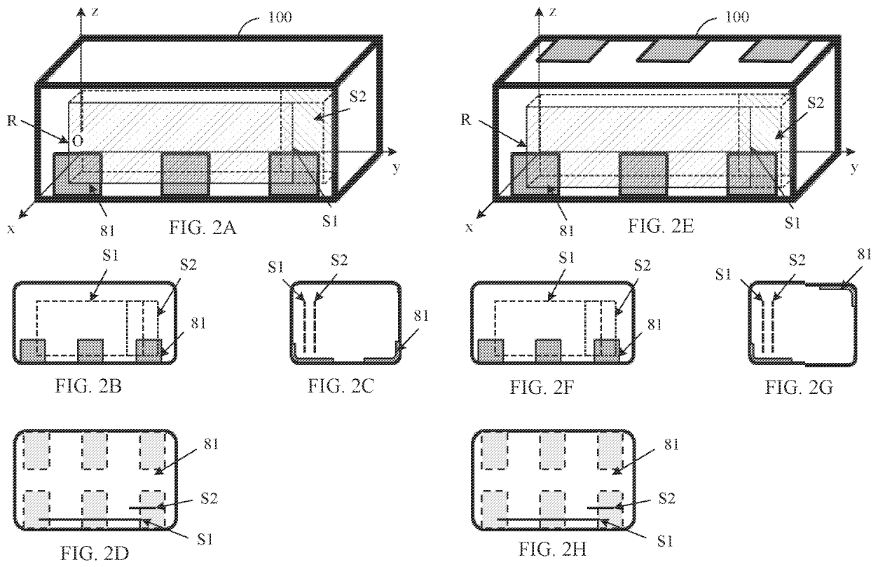

To intuitively and clearly describe a structure setting of the another common mode filter with the low differential mode loss provided in this application, “the common mode filter 100 disposed with three coil assemblies” is used as an example of “the common mode filter including the at least two coil assemblies in this application” for description, and “131”, “132”, and “133” respectively indicate wires belonging to the different coil assemblies, namely, wires marked as 131 in each wiring layer belong to wires of the first coil assembly, wires marked as 132 in each wiring layer belong to wires of the second coil assembly, and wires marked as 132 in each wiring layer belong to wires of the third coil assembly. When a quantity of the coil assemblies is two or more, a person skilled in the art may make a corresponding adjustment with reference to a layout setting of “the common mode filter disposed with three coil assemblies”. Details are not described again in this application. FIG. 2A to FIG. 2D are a 3D diagram, a main view, a side view, and a top view of another schematic common mode filter according to an embodiment of this application, and FIG. 2E to FIG. 2H show a 3D diagram, a main view, a side view, and a top view of still another schematic common mode filter according to an embodiment of this application. FIG. 2A and FIG. 2E are 3D diagrams of different common mode filters according to an embodiment of this application, and FIG. 2B and FIG. 2F are main views of different common mode filters according to an embodiment of this application. FIG. 2C and FIG. 2G are side views of different common mode filters according to an embodiment of this application. FIG. 2D and FIG. 2H are top views of different common mode filters according to an embodiment of this application.

FIG. 3A and FIG. 3B are cross section diagrams of a common mode filter according to an embodiment of this application, and FIG. 3C is a schematic diagram of a structure of a common mode filter according to an embodiment of this application. FIG. 3A is a cross section diagram obtained by cutting along a location of a section S1 shown in FIG. 2E to FIG. 2H and FIG. 3C, and FIG. 3B is a cross section diagram obtained by cutting along a location of a section S2 shown in FIG. 2E to FIG. 2H and FIG. 3C. The section S1 and the section S2 correspond to the same three-dimensional space R of the common mode filter 100. In addition, for brief illustration, the common mode filter in FIG. 3C only shows three dielectric mechanical parts and four wiring layers, and the common mode filters in FIG. 3A and FIG. 3B also only shows five dielectric mechanical parts and six wiring layers.

As shown in FIG. 3A, FIG. 3B, and FIG. 3C, the common mode filter 100 includes three coil assemblies, a plurality of wiring harnesses 14, at least one dielectric mechanical parts 12, and a plurality of wiring layers 11. Each coil assembly includes a plurality of wires (a wire is made of metal), that is, wires 131 in each wiring layer 11 belong to wires of the first coil assembly, wires 132 in each wiring layer 11 belong to wires of the second coil assembly, and wires 133 in each wiring layer 11 belong to wires of the third coil assembly. One or more wires belonging to different coil assemblies are disposed in each wiring layer 11 (for example, the wires 131, 132, 133 of each coil assembly are disposed in each wiring layer 11 as shown in FIG. 3A. FIG. 3B, and FIG. 3C). Each wiring harness 14 is connected to two wires that belong to a same coil assembly 13 and have a shortest interlayer distance in different wiring layers 11 (for example, a wiring harness shown in FIG. 3A, FIG. 3B, and FIG. 3C may be connected to two wires 131 in two adjacent wiring layers 11), and the plurality of wiring harnesses 14 are used to sequentially connect a plurality of wires of each coil assembly 13. Each dielectric mechanical part 12 is located between the two adjacent wiring layers 11. The plurality of wiring layers 1I are stacked together under effect of a plurality of dielectric mechanical parts 12, and may maintain a parallel state or an approximately parallel state with each other under support of the dielectric mechanical part 12. That the plurality of wiring layers 11 described in this application may maintain the parallel state or the approximately parallel state with each other under the support of the dielectric mechanical part 12 may mean a state in a theoretical design. In an actual manufacturing process, there is a specific deviation of “parallel or approximately parallel” between the plurality of wiring layers 11 due to problems such as a technique, a material, and the like.

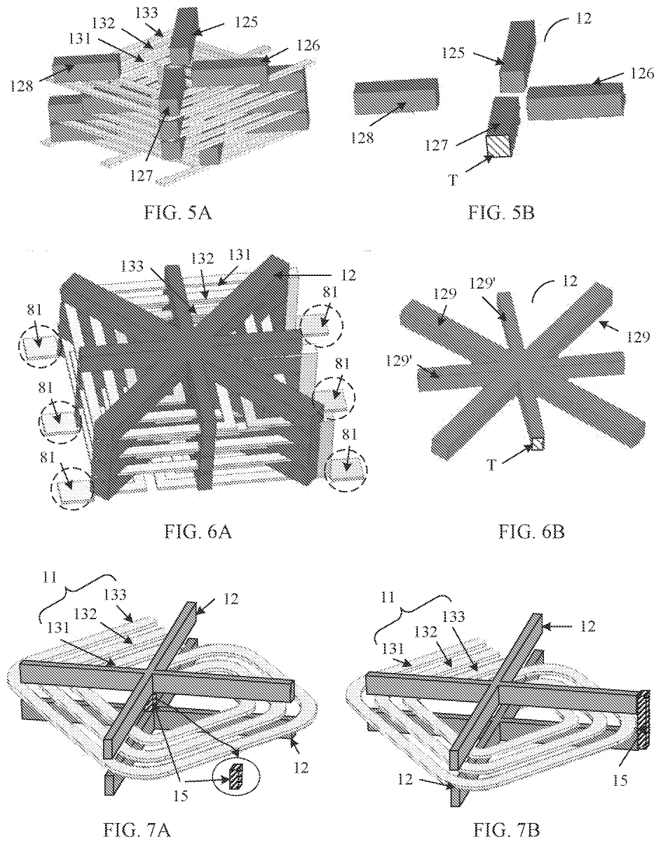

In the common mode filter with the dielectric mechanical part separately shown in FIG. 3A to FIG. 3C, FIG. 4A, FIG. 5A, FIG. 6A, and the like, a wiring layout manner may be a layout manner shown in the accompanying drawings corresponding to the common mode filter. A wiring layout of the common mode filter with the dielectric mechanical part in FIG. 3A to FIG. 3C, FIG. 4A. FIG. 5A, and FIG. 6A may be set with reference to a wiring layout manner shown in FIG. 1B to FIG. 1G. Other settings for the wiring layout of the common mode filter with the dielectric mechanical part may also be made as required. This is not limited in this application.

Under a requirement and a premise that maintenance of the parallel state or the approximately parallel state of the plurality of wiring layers of the common mode filter is ensured and a structure of the common mode filter is stable, a layout manner between wires in a same wiring layer, a structure of each dielectric mechanical part, and a shape and a location of each wiring harness may be set. This is not limited in this application. To further describe a setting of each part of the common mode filter in this application, different parts of the common mode filter are described below with reference to examples provided in the accompanying drawings of this application. FIG. 3D, FIG. 4B, FIG. 5B, and FIG. 6B are schematic diagrams of structures of a dielectric mechanical part according to different embodiments of this application. FIG. 4A, FIG. 5A, and FIG. 6A are schematic diagrams of structures of a common mode filter according to different embodiments of this application. FIG. 3D and FIG. 3C show a same common mode filter, and FIG. 4A and FIG. 4B, FIG. 5A and FIG. 5B, FIG. 6A and FIG. 6B separately correspond to a same common mode filter.

In a possible implementation, each dielectric mechanical part 12 may include at least one mechanical branch (for example, mechanical branches 122, 121, 122′, and 121′ shown in FIG. 3D; or mechanical branches 123 and 124 shown in FIG. 4B; or mechanical branches 125, 126, 127, and 128 shown in FIG. 5B; or mechanical branches 129 and 129′ shown in FIG. 6B). A quantity, a structure, and a spatial location in the common mode filter of the mechanical branch of the dielectric mechanical part may be correspondingly set based on a setting of each wire in a wiring layer that is in contact with the dielectric mechanical part.

As shown in FIG. 5A and FIG. 5B, all mechanical branches of a same dielectric mechanical part 12 may not be connected to each other. Alternatively, as shown in FIG. 3C. FIG. 3D. FIG. 4A, FIG. 4B, FIG. 6A, and FIG. 6B, all the mechanical branches of the same dielectric mechanical part 12 may be fixedly connected together by manufacturing the dielectric mechanical part into an integrated structure. Alternatively, all the mechanical branches of the same dielectric mechanical part 12 may be partially connected together. In this way, structural stability of the dielectric mechanical part may be enhanced, thereby improving structural stability of the common mode filter. Alternatively, all the mechanical branches of the same dielectric mechanical part may not be connected to each other, or may not be completely fixedly connected together. For example, a part of mechanical branches are fixedly connected together, remaining mechanical branches are not connected to each other, and the like. Whether all the mechanical branches of the same dielectric mechanical part are fixedly connected together and a connection manner between the mechanical branches is set are not limited in this application.

In a possible implementation, dielectric mechanical parts in different layers may be connected through a connector, and a location of the connector is not limited. For example, FIG. 7A and FIG. 7B are schematic diagrams of structures of a connector according to different embodiments of this application. The common mode filter 100 may further include at least one connector 15, and each connector 15 is configured to fixedly connect any two dielectric mechanical parts 12 together. The two dielectric mechanical parts 12 connected by each connector 15 may be spaced by one wiring layer, or may be spaced by a plurality of wiring layers and the dielectric mechanical part between the wiring layers. As shown in FIG. 7A, each connector 15 may penetrate each layer between two dielectric mechanical parts 12 connected by the connector 15, to reduce a volume of the common mode filter. As shown in FIG. 7B, the connector 15 may alternatively be disposed outside the plurality of wiring layers 11, so that a processing process of the common mode filter may be simplified, a processing speed may be improved, and a processing technique may be simplified. In some embodiments, when there is a plurality of connectors, each connector may be a discrete structure shown in FIG. 7A and FIG. 7B. Alternatively, all the connectors may be connected together to be an integrated structure. Disposing the connector may improve the structural stability of the common mode filter.

For example, assuming that a common mode filter has seven wiring layers “Z1, Z2, . . . and Z7” and six dielectric mechanical parts “M1, M2, . . . , and M6” respectively, the common mode filter may further include five connectors “L1, L2, . . . , and L5” respectively, and a connection relationship between each connector and the dielectric mechanical part may be the following possible cases such as “a possible case 1, a possible case 2, possible case 3”, or the like.

In the possible case 1, L1 is separately connected to M1 and M2, L2 is separately connected to M2 and M3, L3 is separately connected to M3 and M4, L4 is separately connected to M4 and M5, and L5 is separately connected to M5 and M6.

In the possible case 2, L1 is separately connected to M1 and M6, L2 is separately connected to M2 and M6, L3 is separately connected to M3 and M6, L4 is separately connected to M4 and M6, and L5 is separately connected to M5 and M6.

In the possible case 3, L1 is separately connected to M1 and M3, L2 is separately connected to M2 and M3, L3 is separately connected to M3 and M4, L4 is separately connected to M3 and M6, and L5 is separately connected to M5 and M3.

In a possible implementation, each mechanical branch is in contact with at least a wiring corner of one wire in one adjacent wiring layer 11. For example, as shown in FIG. 3C, for wires 131, 132, and 133 in a currently shown wiring layer 11 on the top, a dielectric mechanical part 12 under the wiring layer is in contact with four of five corners of the wire 131, four of five corners of the wire 132, and three corners of the wire 133. In this way, each mechanical branch is disposed to be in contact with at least one wiring corner of one wire in the one adjacent wiring layer, so that the wire may be supported by the dielectric mechanical part, to ensure that a mutual parallel state or an approximately parallel state between the plurality of wiring layers may be stably maintained.

In a possible implementation, a section shape of each mechanical branch that is perpendicular to a section T (for example, sections T shown in FIG. 4B, FIG. 5B, FIG. 6B, and the like) of the wiring layer 11 may include any one of the following: a rectangle (for example, a shape of the sections T shown in FIG. 4B, FIG. 5B, FIG. 6B, and the like), a trapezoid, a parallelogram, and a combination shape formed by at least two shapes of the rectangle, the trapezoid, and the parallelogram. Sizes and shapes of sections T that are of the mechanical branches of the same dielectric mechanical part and that are perpendicular to the wiring layer 11 may be the same (for example, the shapes and the sizes of the sections T that are of the mechanical branches and that are perpendicular to the wiring layer 1I are the same as shown in FIG. 4B and FIG. 5B), or may be different (for example, the shapes of the sections T that are of two mechanical branches 129 and two other mechanical branches 129′ in the four mechanical branches shown in FIG. 6B and that are perpendicular to the wiring layer 11 are the same, but the sizes of the sections T are different). In this way, a shape and a size of a section T of each mechanical branch of the dielectric mechanical part may be set based on a support requirement determined by a winding shape, a length, and the like of a wire in the two wiring layers that are in contact with the dielectric mechanical part, and a volume of each mechanical branch may be minimized as much as possible while the support requirement is met, to further reduce a low differential mode loss of the common mode filter.

In a possible implementation, a shape of an orthographic projection of each dielectric mechanical part 12 in any wiring layer includes any one of the following: a grid-shaped shape (as shown in FIG. 3D), a star-shaped shape (as shown in FIG. 6A and FIG. 6B), a square-shaped shape, a rectangle, an X-shaped shape (as shown in FIG. 4A and FIG. 4B), a round shape, a ring shape, an I-shaped shape, a cross shape, and a combination shape formed by at least two shapes of the grid-shaped shape, the star-shaped shape, the square-shaped shape, the rectangle, the X-shaped shape, the round shape, the ring shape, the I-shaped shape, and the cross shape. In this way, the shape of the orthographic projection of the dielectric mechanical part may be set randomly based on a structure support requirement of the common mode filter, and the volume of the dielectric mechanical part may be minimized as much as possible while the support requirement is met, to further reduce the low differential mode loss of the common mode filter.

It should be noted that the foregoing merely provides an example of the section shape of the mechanical branch perpendicular to the wiring layer and the shape of the orthographic projection of the dielectric mechanical part in any wiring layer. A person skilled in the art may set the section shape and the shape of the orthographic projection based on an actual requirement. This is not limited in this application.

In a possible implementation, a volume of each dielectric mechanical part 12 may be less than or equal to 80% of a volume of interlayer space between the two wiring layers that are in contact with each dielectric mechanical part 12; and/or the volume of each dielectric mechanical part may be less than or equal to 80% of a volume of a wiring layer that is in contact with each dielectric mechanical part. In this way, the structural stability of the common mode filter may be ensured, and the differential mode loss may also be reduced. The volume of the dielectric mechanical part may be set based on a setting requirement of the common mode filter. The smaller the volume of the dielectric mechanical part, the lower the differential mode loss of the common mode filter.

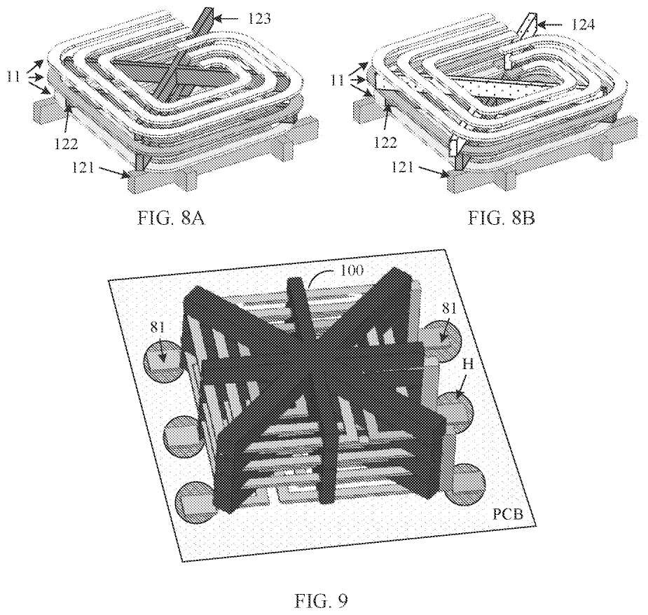

FIG. 8A and FIG. 8B are schematic diagrams of structures of a dielectric mechanical part of yet another schematic common mode filter according to an embodiment of this application. Structures of a plurality of dielectric mechanical parts of a same common mode filter may be the same or similar (for example, in the common mode filters in FIG. 3C, FIG. 4A, and FIG. 6A, the structures of the dielectric mechanical parts of the same common mode filter are similar). Alternatively, in a plurality of dielectric mechanical parts of a same common mode filter, structures of a part of dielectric mechanical parts are similar, and structures of remaining dielectric mechanical parts are different. For example, in three dielectric mechanical parts 121, 122, and 123 of the common mode filter in FIG. 8A, structures of the dielectric mechanical part 122 and the dielectric mechanical part 123 are the same, while a structure of the dielectric mechanical part 121 is different from the structures of the dielectric mechanical part 122 and the dielectric mechanical part 123. Alternatively, structures of a plurality of dielectric mechanical parts of a same common mode filter may be different from each other. For example, structures of three dielectric mechanical parts 121, 122, 124 of the common mode filter in FIG. 8B are different from each other. In FIG. 8A and FIG. 8B, to indicate a difference between the dielectric mechanical parts, a wiring layer is drawn as an example and a wiring harness is not drawn. A person skilled in the art may set the structure of each dielectric mechanical part based on a layout of wires in different wiring layers of the same common mode filter. This is not limited in this application.

In a possible implementation, a filler may be further disposed in a part of or all of the plurality of wiring layers, and the filler includes a porous solid filler and/or a gas filler. A material of the porous solid filler may include a solid material with a small Dk and/or df, for example, a solid material with Dk≤10 and/or df≤0.1. Alternatively, space of the wiring layer other than space in which a wire is located may be in a vacuum state. A volume of the filler in each wiring layer is less than or equal to 80% of a total volume of the wiring layer in which the filler is located. In this way, structural stability of the common mode filter may be enhanced, and a differential mode loss may be minimized as much as possible. The smaller the volume of the filler in the wiring layer, the lower the differential mode loss of the common mode filter.

In a possible implementation, the porous solid filler in each wiring layer may include at least one of the following: insulation foam, porous ceramic, and porous resin. Materials of porous solid fillers filled in the different wiring layers may be the same or different.

In a possible implementation, the porous solid filler in each wiring layer 11 may be fixedly connected to a dielectric mechanical part 12 that is in contact with the wiring layer 11. In this way, the structural stability of the common mode filter may be enhanced.

Because each wiring harness is separately connected to ends of two wires that need to be connected. A location of the end of the wire and an obstacle (for example, the dielectric mechanical part, the porous solid filler, and the like) between the ends of the two wires have different impact on a setting of a spatial location occupied by each wiring harness. Therefore, an implementation of the wiring harness may include the following possible cases a, b, and c.

In the possible case a, if the spatial location of the wiring harness is full of gas, that is, there is no obstacle between the ends of the two wires connected to the wiring harness, the wiring harness may be directly disposed between wiring layers in which the two wires that need to be connected are located. The wiring harness may be a metal wire, a metal column, or the like. For example, if a wiring layer of the common mode filter in FIG. 3C is filled with air, the wiring harness 14 may be the metal column.

In the possible case b, if the spatial location of the wiring harness is occupied by the dielectric mechanical part, the porous solid filler, and/or the like, a plated through hole may be disposed in a first part of space to be occupied by the wiring harness in the dielectric mechanical part. In the porous solid filler, a through hole is disposed in a second part of space to be occupied by the wiring harness, and a metal wire or a metal column is disposed in the through hole. Then the plated through hole disposed in the first part of space, and/or the metal wire or the metal column in the through hole in the second part of space are/is used as the wiring harness connecting the ends of the two wires.

In the possible case c, if a part of the spatial location in which the wiring harness is located is occupied by the dielectric mechanical part, the porous solid filler, and the like, and remaining spatial location is occupied by air, a plated through hole may be disposed in a first part of space to be occupied by the wiring harness in the dielectric mechanical part. In the porous solid filler, a through hole is disposed in a second part of space to be occupied by the wiring harness, and a metal wire or a metal column is disposed in the through hole. In the air, the metal wire or the metal column is disposed in a third part of space to be occupied by the wiring harness. Then the plated through hole disposed in the first part of space, the metal wire or the metal column in the through hole in the second part of space, and/or the metal wire or the metal column in the third part of space are/is used as the wiring harnesses connecting the ends of the two wires.

In a possible implementation, the common mode filter 100 may further include at least one interlayer via hole, and each interlayer via hole is used to accommodate a corresponding connector. That is, if space that needs to be occupied by the connector is partially or completely occupied by another part (for example, the porous solid filler or the like) of the common mode filter, the connector may be accommodated in a manner of disposing the interlayer via hole.

In a possible implementation, the common mode filter 100 may further include a plurality of pins 81. As shown in FIG. 2E to FIG. 2H and FIG. 3C, the plurality of pins 81 may be disposed on surfaces of two outermost wiring layers 11 of the plurality of wiring layers 11. Alternatively, as shown in FIG. 2A to FIG. 2D and FIG. 6A, the plurality of pins 81 may be disposed on a surface of any one of two outermost wiring layers 11 of the plurality of wiring layers 11.

The plurality of pins 81 of the common mode filter 100 are disposed on a surface of a same wiring layer, so that the common mode filter may be easily moved, and the common mode filter may be easily transferred to and mounted on a corresponding solder pad location of a printed circuit board PCB.

In a possible implementation, a layout manner of the wires in the wiring layer may be set based on a quantity of wires included in the wiring layer. At least two wires in the wiring layer whose quantity of wires is greater than or equal to 2 may be wound in parallel, to improve symmetry of the common mode filter. Parallel winding between wires in a same wiring layer means that the wires that need to be wound in parallel in the same wiring layer are wound in parallel to each other. The wires wound in parallel have a same phase.

For each wire in each wiring layer, if the wire participates in the parallel winding, a part of or all segments of the wire may participate in the parallel winding. Based on a winding situation, each part of wire segments of the wire may include at least one of the following segments: a first part of wire segments that are wound in parallel with all other wires participating in the parallel winding, a second part of wire segments that are wound in parallel with a part of all other wires participating in the parallel winding, and a third part of wire segments that are not wound in parallel with the other wires.

In a possible implementation, the common mode filter 100 may further include an encapsulation layer. The encapsulation layer is used to encapsulate parts (including the dielectric mechanical part, the wiring layer, and the like) of the common mode filter 100 together, and expose each pin 81 to an outer part of the encapsulated common mode filter 100, to facilitate mounting of the common mode filter 100.

FIG. 9 is a schematic diagram of a structure of a filtering apparatus according to an embodiment of this application. As shown in FIG. 9, the filtering apparatus includes a common mode filter 100 and a first printed circuit board (PCB). The first printed circuit board (PCB) is configured to carry the common mode filter 100. Each pin 81 of the common mode filter 100 is fixedly connected to a corresponding solder pad H on the PCB.

A manner in which each pin 81 of the common mode filter 100 is fixedly connected to the corresponding solder pad H on the PCB may include any one of the following: a wire bonding connection, a welding connection, and a conductive adhesive bonding connection (for example, a conductive silver paste and the like).

If each pin 81 of the common mode filter 100 is on a surface of a same wiring layer as shown in FIG. 9, adsorption apparatuses such as a vacuum suction tube and the like may be used to transfer the common mode filter 100 to the PCB and ensure that a location of each pin 81 is above the corresponding solder pad H. Alternatively, a part of a surface of the common mode filter 100 may be coated with insulation adhesive, and the common mode filter 100 is transferred to the PCB by using the insulation adhesive.

This application further provides an apparatus having a filtering function. The apparatus includes a functional device, an auxiliary device, and a second printed circuit board. The functional device includes the common mode filter 100 described above. The auxiliary device includes an amplifier and/or a passive device. The functional device and the auxiliary device are mounted on the second printed circuit board, and the functional device and the auxiliary device are coupled and connected.

The second printed circuit board has a first surface and a second surface that are disposed relative to each other. A plurality of solder pads are disposed on the first surface, and a plurality of apparatus pins are disposed on the second surface. Each pin of each functional device and each auxiliary device is fixedly connected to a corresponding solder pad on the first surface.

In a possible implementation, a manner in which each pin is fixedly connected to a corresponding solder pad on the second printed circuit board may include any one of the following: a wire bonding connection, a welding connection, and a conductive adhesive bonding connection (for example, a conductive silver paste and the like).

In a possible implementation, for the common mode filter 100 in the functional device, if each pin 81 of the common mode filter 100 is on a surface of a same wiring layer, adsorption apparatuses such as a vacuum suction tube and the like may be used to transfer the common mode filter 100 to the apparatus printed circuit board and ensure that a location of each pin 81 is above the corresponding solder pad. Alternatively, a part of a surface of the common mode filter 100 may be coated with insulation adhesive, and the common mode filter 100 is transferred to the apparatus printed circuit board by using the insulation adhesive.

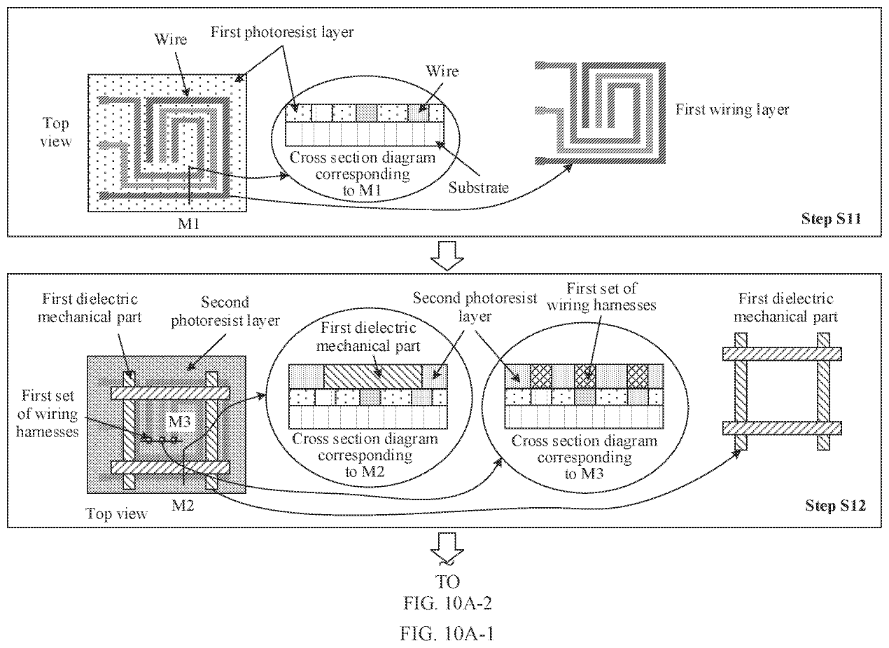

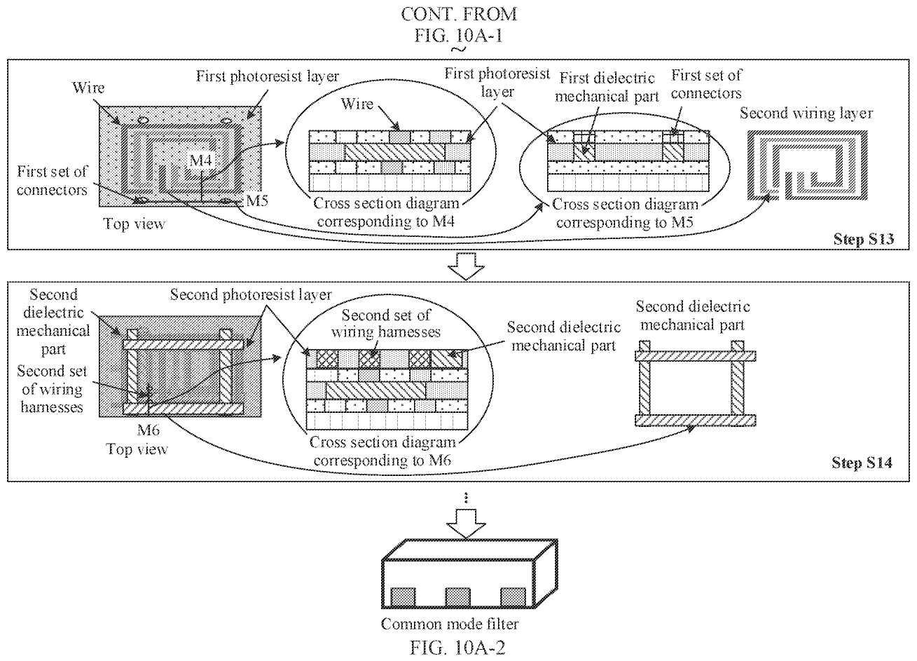

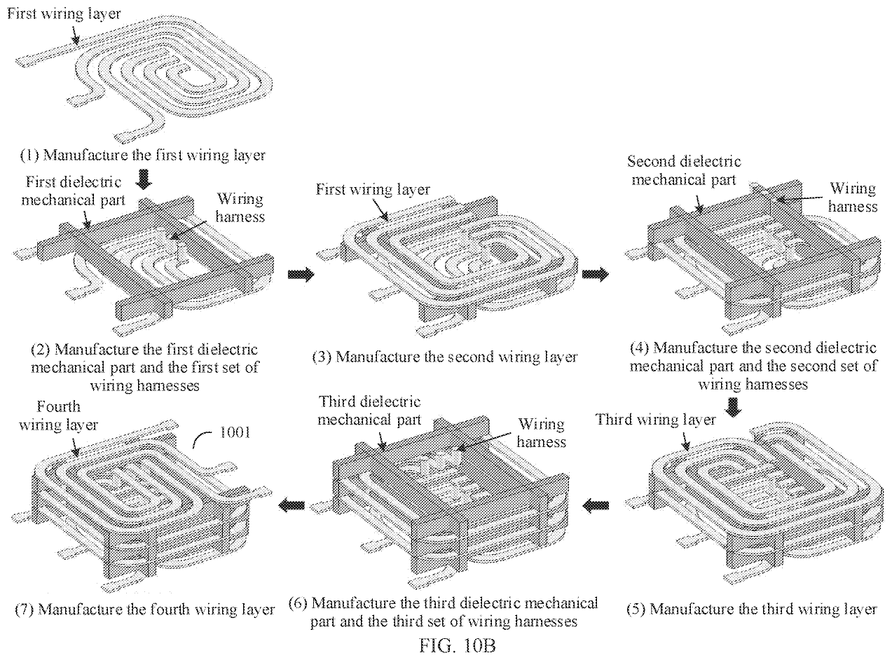

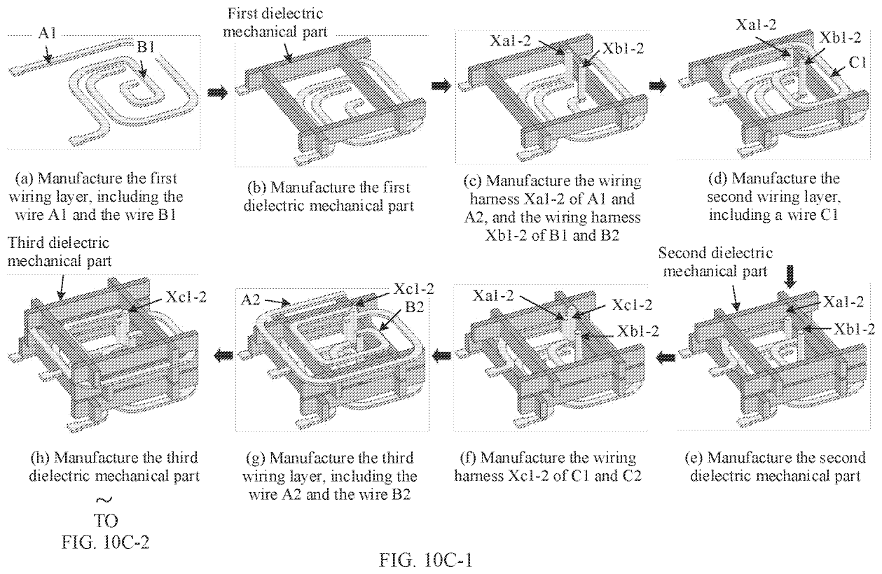

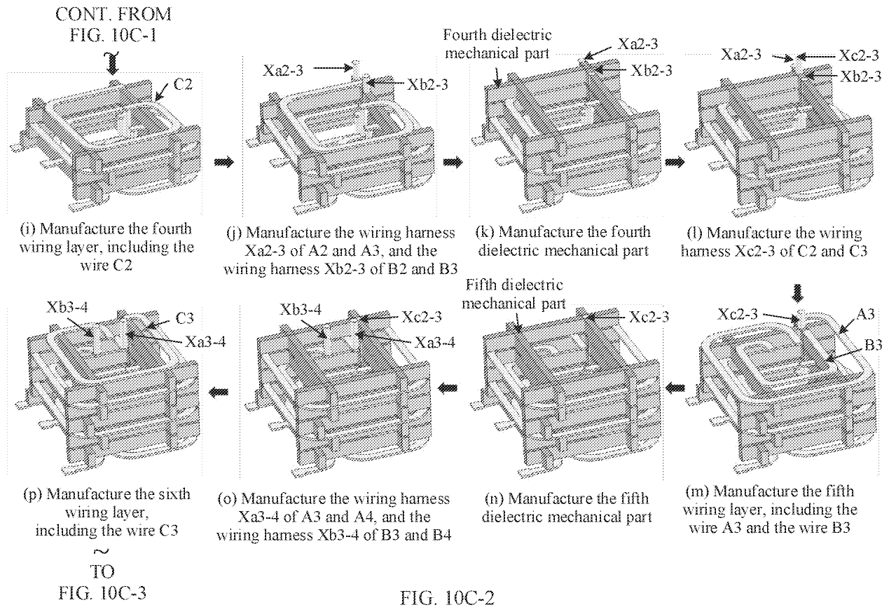

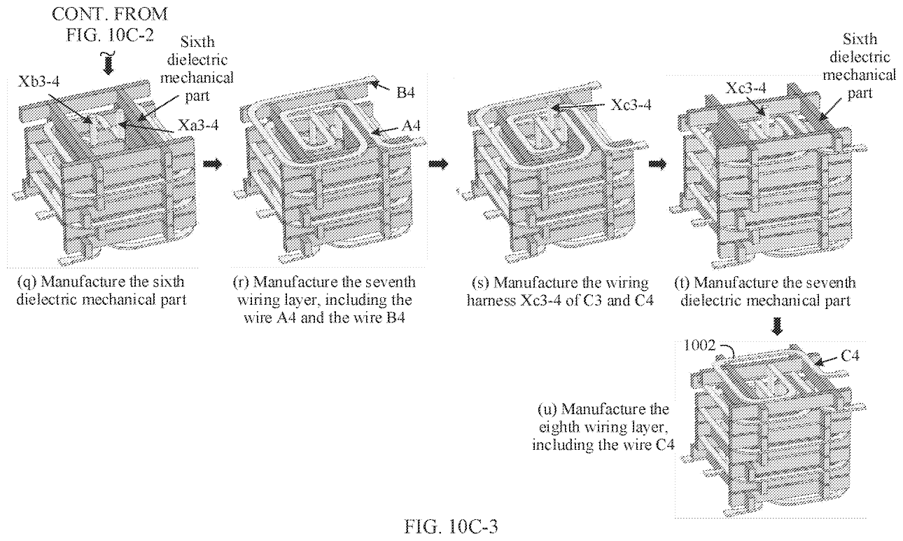

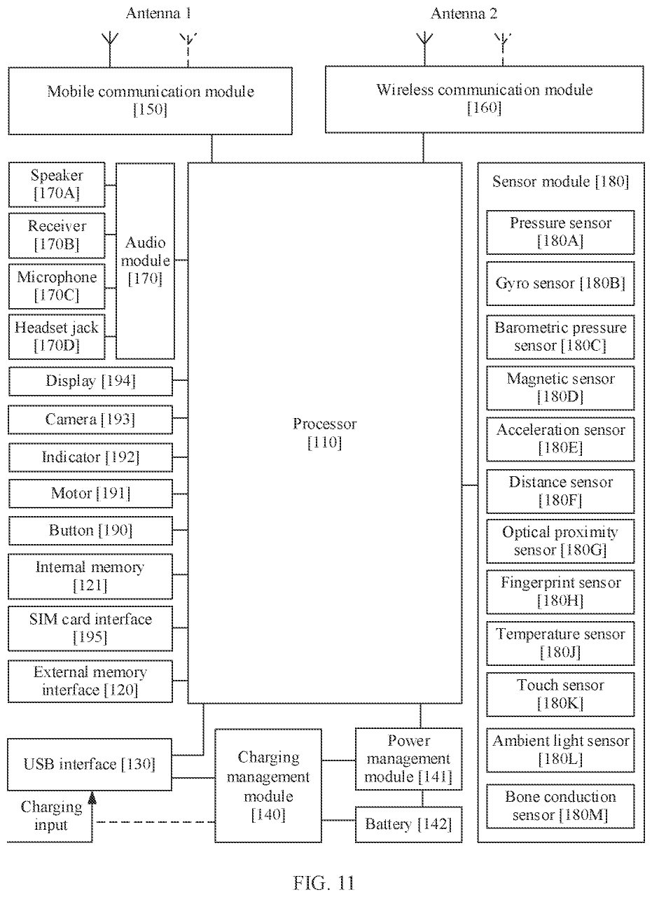

This application further provides a method for manufacturing a common mode filter, used to manufacture the common mode filter 100 described above. FIG. 10A-1 and FIG. 10A-2, FIG. 10B, and FIG. 10C-1 to FIG. 10C-3 are schematic diagrams of manufacturing processes of a common mode filter according to an embodiment of this application. To clearly show that parts of the common mode filter generated in different steps are different, FIG. 10B only shows related parts constituting the common mode filter, and does not show a photoresist, a substrate, and the like. FIG. 10A-1 and FIG. 10A-2 show a processing process of manufacturing the common mode filter. FIG. 10B and FIG. 10C-1 to FIG. 10C-3 are two examples of the common mode filter manufactured according to the method shown in FIG. 10A-1 and FIG. 10A-2. To facilitate description of a processing and manufacturing process, in FIG. 10A-1 and FIG. 10A-2, “each wiring layer includes three wires that belong to different coil assemblies” is used as an example for description. Actually, each wiring layer may include at least one wire, and wires belong to different coil assemblies.

As shown in FIG. 10A-1 and FIG. 10A-2, the method includes the following steps.

In step S11, as shown in “step S11” in FIG. 10A-1 and FIG. 10A-2, if the first wiring layer does not need to be filled with a porous solid filler, a metal layer and a first photoresist layer are sequentially prepared on the substrate, and the metal layer is etched based on a quantity of wires in the first wiring layer and a layout of the wire, to form the first wiring layer.

If the first wiring layer needs to be filled with the porous solid filler, step S11 may be: sequentially preparing the metal layer and the first photoresist layer on the substrate, etching the metal layer based on the quantity of wires in the first wiring layer and the layout of the wire, to form each wire in the first wiring layer, further etching the first photoresist layer to form filling space, and filling the filling space with porous solids to obtain the first wiring layer, where the first wiring layer includes each wire and the porous solid filler (not shown in the figure).

In the foregoing two types of step S11, as shown in a top view of step S11 in FIG. 10A-1 and FIG. 10A-2 and a cross section diagram corresponding to M1 (a cross section diagram obtained by cutting, in the top view of step S11, a section that is perpendicular to the substrate and that corresponds to the line segment M1), after preparation of the first wiring layer is completed, a remaining first photoresist layer may be reserved, to facilitate subsequent preparation of a dielectric mechanical part, the wiring layer, and the like.

In addition, to meet requirements of processing processes of different wiring layers, a requirement of an interlayer binding force, and the like, a process used for preparing a metal layer corresponding to each wiring layer may be set based on an actual requirement. Each metal layer may be prepared by using one or more of techniques such as electroplating, magnetron sputtering, and the like. Techniques used for preparation of each metal layer may be the same or different. For example, in step S11, a metal layer of specific thickness may be first generated on the substrate through the magnetron sputtering, and then the metal layer continues to be electroplated to generate a metal layer of specific thickness. The metal layer obtained through the magnetron sputtering and the metal layer obtained through electroplating jointly form a metal layer required for forming the first wiring layer. In this way, a binding force between the first metal layer and the substrate may be improved, and preparation efficiency of the metal layer may be ensured.

In step S12, as shown in “step S12” in FIG. 10A-1 and FIG. 10A-2, a dielectric layer and a second photoresist layer are prepared in the first wiring layer and the remaining first photoresist layer, and the dielectric layer is etched based on a layout of each wire in the first wiring layer and a layout of each wire in a second wiring layer to be supported by the first dielectric mechanical part, to form the first dielectric mechanical part.

After step S12 is completed, as shown in a top view of step S12 in FIG. 10A-1 and FIG. 10A-2, a cross section diagram corresponding to M2 (a cross section diagram obtained by cutting, in the top view of step S12, a section that is perpendicular to the substrate and that corresponds to the line segment M2), and a cross section diagram corresponding to M3 (a cross section diagram obtained by cutting, in the top view in step S12, a section that is perpendicular to the substrate and that corresponds to the line segment M3), a remaining second photoresist layer may be reserved, to facilitate subsequent preparation of the dielectric mechanical part, the wiring layer, and the like.

In step S13, as shown in “step S13” in FIG. 10A-1 and FIG. 10A-2, the second wiring layer is sequentially prepared in at least the first dielectric mechanical part and the second photoresist layer. For step S13, refer to the preparation process of preparing the first wiring layer in step S11.

After step S13 is completed, as shown in a top view of step S13 in FIG. 10A-1 and FIG. 10A-2, a cross section diagram corresponding to M4 (a cross section diagram obtained by cutting, in the top view of step S13, a section that is perpendicular to the substrate and that corresponds to the line segment M4), and a cross section diagram corresponding to M5 (a cross section diagram obtained by cutting, in the top view in step S13, a section that is perpendicular to the substrate and that corresponds to the line segment M5), the remaining first photoresist layer may be reserved, to facilitate the subsequent preparation of the dielectric mechanical part, the wiring layer, and the like.

In step S14, as shown in “step S14” in FIG. 10A-1 and FIG. 10A-2, the second dielectric mechanical part is prepared in the second wiring layer and the remaining first photoresist layer (which may also include a first set of connectors). For step S14, refer to the preparation process of step S12.

After step S14 is completed, as shown in a top view of step S14 in FIG. 10A-1 and FIG. 10A-2 and a cross section diagram corresponding to M6 (a cross section diagram obtained by cutting, in the top view of step S14, a section that is perpendicular to the substrate and that corresponds to the line segment M6), the remaining second photoresist layer may be reserved, to facilitate the subsequent preparation of the dielectric mechanical part, the wiring layer, and the like.

Then, with reference to the steps of preparing the wiring layer, the dielectric mechanical part, the wiring harness, and the connector in step S11 to step S14, preparation of a remaining wiring layer, the dielectric mechanical part, the wiring harness, and the connector is implemented, and then all remaining photoresist is removed, to obtain the common mode filter shown in FIG. 10A-1 and FIG. 10A-2.

After step S11, and before preparation of the common mode filter is completed, the method may include the following steps.

### Wiring Harness Preparation Step:

Because each wiring harness is used for performing a connection between wires between different wiring layers in a same coil assembly (for example, a connection between two wires with a shortest interlayer distance), it is assumed that a target wiring harness is used to implement a connection between a pre-prepared wire and a post-prepared wire in a same coil assembly, and a corresponding target wiring harness needs to be generated before preparation of the post-prepared wire, to ensure that the pre-prepared wire and the post-prepared wire may be connected together. For example, because the first set of wiring harnesses in FIG. 10A-1 and FIG. 10A-2 is used to connect wires of different coil assemblies in the first wiring layer and the second wiring layer, before preparation of the second wiring layer, for example, after preparation of the first dielectric mechanical part in step S12, the second photoresist layer and/or the first dielectric mechanical part are/is etched based on spatial locations of the first set of wiring harnesses (spatial locations of wiring harnesses in the first set of wiring harnesses may be determined based on relative locations of “the wire in the first wiring layer” and “the wire in the second wiring layer” that belong to a same coil assembly and that are connected to the first set of wiring harnesses) to form holes, and metal is filled in the holes to generate corresponding wiring harnesses. Because the second set of wiring harnesses in FIG. 10A-1 and FIG. 10A-2 is used to connect wires of different coil assemblies in the second wiring layer and the third wiring layer, before preparation of the third wiring layer, for example, after preparation of the second dielectric mechanical part in step S14, the second photoresist layer and/or the second dielectric mechanical part are/is etched based on spatial locations of the second set of wiring harnesses (spatial locations of wiring harnesses in the second set of wiring harnesses may be determined based on relative locations of “the wire in the second wiring layer” and “a wire in the third wiring layer” that belong to a same coil assembly and that are connected to the second set of wiring harnesses) to form holes, and metal is filled in the holes to generate corresponding wiring harnesses.

### Connector Preparation Step:

If the common mode filter includes the connector, and the connector is located between layers of the common mode filter, each connector needs to be prepared in a procedure of the steps of preparing the common mode filter. Because each connector needs to fixedly connect a pre-prepared dielectric mechanical part and a post-prepared dielectric mechanical part together, each connector may be prepared based on a spatial position of the connector before preparation of the post-prepared dielectric mechanical part. For example, the first set of connectors in FIG. 10A-1 and FIG. 10A-2 includes four connectors, and the four connectors are used to connect the first dielectric mechanical part and the second dielectric mechanical part together. Therefore, after preparation of the second wiring layer is completed in step S13, if the second wiring layer includes the porous solid filler and there is a connector that passes through the porous solid filler, the porous solid filler needs to be etched first to form each interlayer via hole, and then the first set of connectors is formed based on each interlayer via hole and a spatial location of each connector. If the second wiring layer does not include the porous solid filler, before the first set of connectors is formed, the first photoresist layer in a layer in which the second wiring layer is located needs to be etched to form space for accommodating each connector, to form the first set of connectors.

If the common mode filter includes the connector, and the connector is located outside the common mode filter instead of between the layers, the connector may be prepared after each dielectric mechanical part and each wiring layer are prepared. Alternatively, different parts of the connector may be synchronously prepared based on the spatial position of the connector following a preparation process of each dielectric mechanical part and each wiring layer.

If the common mode filter includes the connector, a part of the connector is located outside the common mode filter instead of between the layers, and a remaining part is located between the layers, the different parts of the connector may be synchronously prepared based on the spatial position of the connector following the preparation process of each dielectric mechanical part and wiring layer.

It should be noted that each connector only needs to be prepared before the post-prepared dielectric mechanical part in the two dielectric mechanical parts connected by the connector is manufactured. Specific preparation time of the connector is not limited. Similarly, each wiring harness only needs to be prepared before a post-prepared wire of the two wires connected by the wiring harness is manufactured. Specific preparation time of the wiring harness is not limited.

After the foregoing steps are completed, a newly generated layer may be polished by using a chemical mechanical polishing (Chemical Mechanical Polishing, CMP) technology, so that obtained layers may be flat and have no scratch, that is, surface roughness is reduced, and a residual impurity on a surface may be removed. Preparation of each layer may select an appropriate film processing technique such as the electroplating or sputtering based on a film layer material, to prepare a film layer.

With reference to the foregoing method shown in FIG. 10A-1 and FIG. 10A-2, two examples of the common mode filter shown in FIG. 10C-1 to FIG. 10C-3 and FIG. 10B may be manufactured. No connector is shown for a common mode filter 1001 in FIG. 10B and a common mode filter 1002 in FIG. 10C-1 to FIG. 10C-3. The connector may alternatively be disposed for the common mode filter 1001 and the common mode filter 1002.

As shown in FIG. 10B, the common mode filter 1001 that may be prepared through steps (1) to (7) has three coil assemblies, and a same wiring layer includes three wires of different coil assemblies. Each dielectric mechanical part has a same structure and a same size, and an orthographic projection on the first wiring layer is located in a same area.

As shown in FIG. 10C-1 to FIG. 10C-3, the common mode filter 1002 may be prepared through steps (a) to (u). The common mode filter 1002 also includes three coil assemblies, and the first coil assembly includes wires A1, A2, A3, and A4. The second coil assembly includes wires B1, B2, B3, and B4. The third coil assembly includes wires C1, C2, C3, and C4. A difference between the common mode filter 1002 and the common mode filter 1001 lies in that space occupied by an entire device and a quantity of layers included in the entire device are different, and the wiring layer only includes wires of two coil assemblies (the first coil assembly and the second coil assembly) or one coil assembly (the third coil assembly).

Example 1: Similarly, an example in which the common mode filter has three coil assemblies is used. The common mode filter also includes three coil assemblies, and the first coil assembly includes wires A1 and A2. The second coil assembly includes wires B1 and B2. The third coil assembly includes wires C1 and C2. The first wiring layer may include A1, the second wiring layer includes B1 and C1, the third wiring layer includes C2, and the fourth wiring layer includes B2 and A2.

That is, when the wiring layer only includes wires of a part of coil assemblies, the wiring layer that “includes wires of a part of coil assemblies” may include wires belonging to the same “part of coil assemblies” (for example, both the first wiring layer and the third wiring layer in FIG. 10C-1 to FIG. 10C-3 include “the wires of the first coil assembly and the second coil assembly”), wires belonging to completely different coil assemblies (for example, the first wiring layer includes A1 and the third wiring layer includes C2 in Example 1), and wires in which a part of the wires belong to a same coil assembly and remaining wires belong to different coil assemblies (for example, the second wiring layer includes B1 and C1, and the fourth wiring layer includes B2 and A2 in Example 1).

It should be noted that the foregoing process of manufacturing the common mode filter is merely a feasible example. A person skilled in the art may refer to the foregoing example and a layout of each layer of the common mode filter, and use a processing technique applicable to each layer to prepare layer by layer. This is not limited in this application.

FIG. 11 is a schematic diagram of a structure of an electronic device according to an embodiment of this application. As shown in FIG. 11, the electronic device may include at least one of a mobile phone, a foldable electronic device, a tablet computer, a desktop computer, a laptop computer, a handheld computer, a notebook computer, an ultra-mobile personal computer (ultra-mobile personal computer, UMPC), a netbook, a cellular phone, a personal digital assistant (personal digital assistant, PDA), an augmented reality (augmented reality, AR) device, a virtual reality (virtual reality, VR) device, an artificial intelligence (artificial intelligence, A1) device, a wearable device, a vehicle-mounted device, a smart home device, or a smart city device. A specific type of the electronic device is not specially limited in this embodiment of this application.

The electronic device may include a processor 110, an external memory interface 120, an internal memory 121, a universal serial bus (universal serial bus, USB) connector 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and other components. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

A common mode filter may be disposed in a transmission line between the processor 110 and the display 194 in the foregoing electronic device, disposed in a transmission line between the processor 110 and the camera 193, and/or disposed in a transmission line between the processor 110 and the internal memory 121, to filter out a signal between the processor 110 and the display 194, a signal between the processor 110 and the camera 193, and/or a signal between the processor 110 and the internal memory 121 in the transmission line in which the common mode filter is located.

It may be understood that the structure shown in this embodiment of this application does not constitute a specific limitation on the electronic device. In some other embodiments of this application, the electronic device may include more or fewer components than those shown in the figure, or combine some components, or split some components, or have different component arrangements. The components shown in the figure may be implemented by hardware, software, or a combination of the software and the hardware.

Flowcharts and block diagrams in the accompanying drawings show system architectures, functions, and operations that may be implemented by an apparatus, a system, a method, and a computer program product according to embodiments of this application. In this regard, each block in the flowcharts or block diagrams may represent a module, a program segment, or a part of instructions, and the module, the program segment, or the part of the instructions includes one or more executable instructions for implementing a specified logical function. In some alternative implementations, a function marked in the block may also occur in a sequence different from that marked in the accompanying drawings. For example, two consecutive blocks actually may be essentially performed in parallel, or sometimes may be performed in a reverse order, depending on a function involved.

It should also be noted that each block in the block diagrams and/or the flowcharts, and a combination of blocks in the block diagrams and/or the flowcharts may be implemented by the hardware (for example, a circuit or an application-specific integrated circuit (Application-Specific Integrated Circuit, ASIC)) that performs a corresponding function or action, or may be implemented by a combination of hardware and software, for example, firmware and the like.

Although the present invention is described herein with reference to the embodiments, in a process of implementing the present invention that seeks protection, a person skilled in the art may understand and implement other variations of the disclosed embodiments by viewing the accompanying drawings, disclosed content, and the appended claims. In the claims, the word “comprising” (comprising) does not exclude another component or another step, and “a” or “one” does not exclude a case of a plurality of objects. A single processor or another unit may implement several functions enumerated in the claims. Some measures are recorded in dependent claims that are different from each other, but this does not mean that these measures cannot be combined to produce good effect.

The foregoing has described the embodiments of this application. The foregoing descriptions are examples, are not exhaustive, and are not limited to the disclosed embodiments. Many modifications and variations are apparent to a person of ordinary skill in the art without departing from the scope and spirit of the described embodiments. Selection of terms used in this specification is intended to best explain the principles of the embodiments, actual application, or improvements to technologies in the market, or to enable another person of ordinary skill in the art to understand the embodiments disclosed in this specification.

1. An electronic device comprising:
a common mode filter comprising:
at least two coil assemblies, wherein each of the at least two coil assemblies comprise a plurality of wires;
at least two wiring layers, wherein one or more wires of different coil assemblies are disposed in each of the at least two wiring layers, and wherein an interlayer space between the at least two wiring layers has a first volume;
at least one dielectric mechanical part located between two adjacent wiring layers of the at least two wiring layers, wherein the at least two wiring layers are stacked together and supported by the at least one dielectric mechanical part, and wherein a second volume of each of the at least one dielectric mechanical part is less than the first volume; and
a plurality of wiring harnesses, wherein each of the wiring harnesses is connected coupled to two different wires of a same coil assembly to sequentially couple the wires of the same coil assembly together,
wherein the at least two coil assemblies, the wiring harness, the at least one dielectric mechanical part, and the at least two wiring layers are disposed in a stacked manner.

2. The electronic device of claim 1, wherein each of the at least one dielectric mechanical part comprises at least one mechanical branch, and wherein each of the at least one mechanical branch is in contact with one or more wiring corners of one wire in one adjacent wiring layer of the at least two wiring layers.

3. The electronic device of claim 2, wherein a cross sectional shape of each of the at least one mechanical branch perpendicular to the one adjacent wiring layer comprises any one of a rectangle shape, a trapezoid shape, a parallelogram shape, or a combination shape formed by at least two of the rectangle shape, the trapezoid shape, or the parallelogram shape.

4. The electronic device of claim 2, wherein all mechanical branches of a same at least one dielectric mechanical part are fixedly coupled together.

5. The electronic device of claim 1, wherein a shape of an orthographic projection of the at least one dielectric mechanical part in any wiring layer of the at least two wiring layers comprises any one of a grid-shaped shape, a star-shaped shape, a square-shaped shape, a rectangle shape, an X-shaped shape, a round shape, a ring shape, an I-shaped shape, a cross shape, or a combination shape formed by at least two shapes of the grid-shaped shape, the star-shaped shape, the square-shaped shape, the rectangle shape, the X-shaped shape, the round shape, the ring shape, the I-shaped shape, or the cross shape.

6. The electronic device of claim 1, wherein the common mode filter further comprises a filler disposed in a part of or all of the at least two wiring layers and comprising a porous solid filler or a gas filler.

7. The electronic device of claim 6, wherein a third volume of the filler in each of the at least two wiring layers is less than or equal to 80 percent (%) of a total volume of each of the at least two wiring layers in which the filler is located.

8. The electronic device of claim 6, wherein the porous solid filler comprises at least one of insulation foam, porous ceramic, or porous resin.

9. The electronic device of claim 1, wherein the common mode filter further comprises at least one connector configured to fixedly couple any two of the at least one dielectric mechanical part together.

10. The electronic device of claim 9, wherein the common mode filter further comprises at least one interlayer via hole configured to accommodate a corresponding connector.

11. The electronic device of claim 6, wherein the porous solid filler in each of the at least two wiring layers is fixedly coupled to the at least one dielectric mechanical part that is in contact with a corresponding wiring layer of the at least two wiring layers.

12. The electronic device of claim 1, wherein the common mode filter further comprises a plurality of pins disposed on a surface of any one of two outermost wiring layers of the at least two wiring layers.

13. The electronic device of claim 1, wherein the second volume is less than or equal to 80 percent (%) of the first volume or a third volume of a wiring layer of the at least two wiring layers that is in contact with each of a corresponding at least one dielectric mechanical part.

14. The electronic device of claim 1, wherein at least two wires in a wiring layer that is of the at least two wiring layers and that has a quantity of wires greater than or equal to 2 are wound in parallel.

15. A filtering apparatus comprising:
a common mode filter comprising:
at least two coil assemblies, wherein each of the at least two coil assemblies comprises a plurality of wires;
at least two wiring layers, wherein one or more wires of different coil assemblies are disposed in each of the at least two wiring layers, and wherein an interlayer space between the at least two wiring layers has a first volume,
at least one dielectric mechanical part located between two adjacent wiring layers of the at least two wiring layers, wherein the at least two wiring layers are stacked together under an effect of the at least one dielectric mechanical part, and wherein a second volume of each of the at least one dielectric mechanical part is less than the first volume;
a plurality of wiring harnesses, wherein each of the wiring harnesses is coupled to two different wires of a same coil assembly; to sequentially couple the wires of the same coil assembly together; and
a plurality of pins disposed on a surface of any one of two outermost wiring layers of the at least two wiring layers,
wherein the at least two coil assemblies, the wiring harnesses, the at least one dielectric mechanical part, and the at least two wiring layers are disposed in a stacked manner; and
a printed circuit board comprising a solder pad and fixedly connected to the common mode filter,
wherein each of the pins is fixedly coupled to the corresponding solder pad.

16. The filtering apparatus of claim 15, wherein a manner in which each pin is fixedly coupled to the corresponding solder pad comprises any one of a wire bonding connection, a welding connection, or a conductive adhesive bonding connection.

17. The filtering apparatus of claim 15, further comprising an insulation adhesive disposed in a part of or all of an area on a surface of the common mode filter to transfer the common mode filter to a corresponding location on the printed circuit board using the insulation adhesive.

18. An apparatus comprising:
a printed circuit board,
an auxiliary device mounted on the printed circuit board and comprising an amplifier or a passive device; and
a functional device mounted on the printed circuit board, coupled to the auxiliary device, and comprising a common mode filter comprising:
at least two coil assemblies, wherein each of the at least two coil assemblies comprises a plurality of wires;
at least two wiring layers, wherein one or more wires of different coil assemblies are disposed in each of the at least two wiring layers, and wherein an interlayer space between the at least two wiring layers has a first volume;
at least one dielectric mechanical part located between two adjacent wiring layers of the at least two wiring layers, wherein the at least two wiring layers are stacked together under an effect of the at least one dielectric mechanical part, and wherein a second volume of each of the at least one dielectric mechanical part is less than the first volume; and
a plurality of wiring harnesses, wherein each of the wiring harnesses is coupled to two different wires of a same coil assembly, to sequentially couple the wires of the same coil assembly together,
wherein the at least two coil assemblies, the wiring harnesses, the at least one dielectric mechanical part, and the at least two wiring layers are disposed in a stacked manner.

19. (canceled)

20. The apparatus of claim 18, wherein each of the at least one dielectric mechanical part comprises at least one mechanical branch, and wherein each of the at least one mechanical branch is in contact with one or more wiring corners of one wire in one adjacent wiring layer of the at least two wiring layers.

21. The apparatus of claim 20, wherein a cross sectional shape of each of the at least one mechanical branch perpendicular to the one adjacent wiring layer comprises any one of a rectangle shape, a trapezoid shape, a parallelogram shape, or a combination shape formed by at least two shapes of the rectangle shape, the trapezoid shape, or the parallelogram shape.
